(19) United States
(12) Patent Application Publication
(10) Pub. No.: US 2015/0279230 A1
(43) Pub. Date: Oct. 1, 2015

(54) METHOD FOR YOGA INSTRUCTION WITH MEDIA

(71) Applicant: WAI LANA PRODUCTIONS, LLC, Sacramento, CA (US)

(72) Inventors: Sunil Khemaney, Kaneohe, HI (US); Diana Sherer, Placerville, CA (US)

(73) Assignee: WAI LANA PRODUCTIONS, LLC, Sacramento, CA (US)

(21) Appl. No.: 14/225,919

(22) Filed: Mar. 26, 2014

(51) Int. Cl. G09B 19/00; G09B 5/02

(52) U.S. Cl. CPC G09B 19/003; G09B 5/02

(57) ABSTRACT

A method for teaching yoga to a plurality of students comprises mounting a video display connected to a video source, where yoga sequences stored on the video source are played on the video display. Simultaneously, an instructor demonstrates the poses and assists individual students while the video is playing, providing instruction and alternate poses to the students depending upon their skill level.

### BACKGROUND

The present invention relates generally to yoga instruction, and more particularly to a method of instructing yoga which combines traditional live instructor(s) with displays arranged to assist students with their practice.

Teaching of yoga asanas (exercises or poses) may not always be safe and effective for varying reasons. One reason is that students in yoga asana classes tend to be of varying levels of ability and with varying knowledge of asanas, even within structured leveled classes such as “Beginners Class”, “Intermediate Class”, etc. For example, in a “Beginners Class”, there will be varying levels and differences in each student's bodily condition and bodily structure. Also, the teacher must cater to students of all levels so that each person can practice at their own level and get the most benefit from the asanas they are practicing. The teacher must make sure that each student is practicing the asanas in a manner that is safe and effective for that student. This requires explaining and demonstrating the poses clearly and correctly with attention, in a way that can be heard and seen by all the students, while simultaneously watching the students carefully as they practice to ensure they are doing the techniques correctly and safely in the most effective manner. If one of the students is not doing the pose correctly, then the responsible teacher will need to instruct that particular student on how to do the pose properly (providing that the student was in the teacher's line of sight). The teacher needs to provide students with a complete demonstration of the pose while the students practice it, and simultaneously move around the room giving personal help where necessary, such as:

(1) Demonstrating or explaining how to make the pose easier.

(2) How to align the body to prevent injury.

(3) Showing or explaining how to make a pose more challenging.

(4) Helping students know whether they are doing the pose correctly or to get hints on how they can improve.

If by chance the teacher does see a student needing assistance, either because the student is doing a pose incorrectly or the student appears to be frustrated in getting started, in order to be of assistance in teaching that student the teacher will have to stop his or her demonstration to the whole class and go over to give the particular student individualized instruction. This, of course, interrupts the flow of the class and deprives the rest of the class a visual demonstration and/or a verbal instruction.

As the foregoing suggests, it is extremely challenging for one teacher to conduct a class effectively on his or her own. The teacher cannot simultaneously demonstrate a technique while trying to explain the technique verbally because breathing properly (timing the inhalation and exhalation with the movement) is a key component to the technique. Secondly, in order to do the technique properly, the teacher has to be very focused on what he or she is doing, and trying to speak while doing the technique will interfere with the proper execution of the technique. Thirdly, while trying to demonstrate the technique and give verbal instruction simultaneously, the teacher many times cannot adequately see or watch over what the students are doing. For many (if not most) techniques, the students will not even be in the teacher's line of vision. For some poses, the teacher's head is raised up looking to the sky, and for some poses the teacher is looking down to the ground, or to the left or right. The teacher cannot simultaneously be watching over all the students while demonstrating these poses.

Because of this situation, many teachers do not demonstrate poses, but will talk the students through the asanas. If a student is not familiar with an asana, it is difficult for them to know what to do without seeing it demonstrated as they practice. The student then needs to rely on watching other students, who may or may not be doing the pose correctly. Even if there is more than one teacher who can personally assist students while the other teacher demonstrates the poses, there is still the problem of visibility and imperfect audio.

Moreover, in a typical yoga class, it is often difficult for the students to see the teacher at all times. The teacher may be demonstrating at the front of the class and the student's view of the teacher may be obstructed by another student or object in the room. Or the teacher may be walking around the class room giving individualized instruction to particular students. It can also be hard for students to hear everything the teacher is saying, especially if the teacher doesn't have a microphone. Sometimes the teacher may be demonstrating the asana and giving verbal instruction at the same time, which often makes it harder to hear the teacher, and for the teacher to focus on the technique and demonstrate the asana properly. For all of the above reasons, these challenges lead to imperfect practice, as well as the opportunity for injury for students taking such yoga classes.

There have been recent attempts to improve the methods of teaching yoga to students in the last ten years. U.S. Patent Publication No. 2002/0051958 to Khalsa discloses the use of a series of yoga exercises to adjust brain functioning and a storyboarding process, both of which are used as tools in creative thinking sessions. When groups of people are assembled to execute a creative organizational planning session, some of the primary impedances to effective collaboration and decision making are participants' tensions, hidden conflicts, departmental rivalries, physical fatigue and mental distractions. The yoga exercise is said to improve the participants' physical well-being, relieves stress, energizes and calms the nervous system, increases mental focus, and balances the hemispheres of the brain for better decision making.

U.S. Patent Publication No. 2011/0224999 to Baccarella-Garcia teaches a member-accessible internet site that acts a hub for gyms from various locations to host their fitness classes live in either a one-way or two-way feed. A member-accessible internet site provides live one-way, and optional two-way, feeds to multiple live exercise classes being conducted at various remote gym facilities. In the one-way embodiment, the participating member would see the exercise instructor and optionally all or part of the on-site exercise group, but he/she would not be visible to them. In the two-way embodiment, the online participants would also be visible to the instructor on a screen display, which will enable the instructor to critique and correct the exercise technique of the online participants.

U.S. Patent Publication No. 2012/0237910 to Blum et al. discloses an exercise apparatus including a video display that can be used to teach yoga. Memory within the apparatus contains a library of instructional exercise programs, such as yoga, Pilates, body toning and stretching routines. The apparatus may also connect to a network, such as the Internet to stream and/or download additional exercise programs.

U.S. Patent Publication No. 2013/0128053 to Mills teaches a system and method to allow viewer participants to view and take part in an instructional class from any location and at any time without compromising the viewer's ability to experience a participatory class experience. Mills is a different way of filming a yoga class to give the remote participant the feeling of being in the class.

U.S. Patent Publication No. 2013/0216990 to Chu et al. teaches a method for interactive live webcam physical activity classes. A system analyzes each live video stream of physical activity learning sent from web cams to a user interface. The user interface is associated with a webcam that sends a live video stream of physical activity instruction to user interfaces associated with the web cams.

U.S. Patent Publication No. 2013/0222565 to Guerin et al.

Guerin teaches a motion capture system that can be used to analyze a user's movements on a display. The system can be used for collecting motion capture data about a user's position and/or movement and comparing that data to an exemplary position or movement to determine errors in the position or movement. The system can include a single range camera to provide color and depth data as well as inertial sensors to provide inertial measurements.

U.S. Patent Publication No. 2013/0300934 to Cho et al. discloses a method for synchronizing two video feeds together to show how a user's exercise departs from an exemplary exercise. U.S. Pat. No. 8,025,606 to Hamilton teaches a physical exercise method and apparatus that comprises a mat/cushion device and accessories designed for fitness interactivity using an array of variations of graphics specifically placed on the mat. The locations of the graphics are provided as an aid to guide proper body positions or postures, placement and alignment in yoga and physical exercise, and for the use of creative sequencing of movement, proper technique, and body mechanics.

While all of these references try to integrate the instruction of yoga with different technologies, there is still an issue that arises in connection with the instruction of yoga in a large studio with several students. This issue that has arisen in many yoga studios is that a yogi, or instructor, is tasked with both conducting the class, and circulating around the room to provide instruction to individual students. At the same time, the students may be positioned in various poses, such as lying on the ground, looking down, or to one side of the their body, making it difficult or impossible to maintain eye contact with the instructor. Because it is essential that students, particularly new students, be able to view the instructor for safety reasons and for quality yoga practice, the traditional methods for instruction can fall short in this area. The present invention is designed to address this shortcoming of traditional yoga instruction in a studio.

### SUMMARY OF THE INVENTION

The present invention is a method for yoga instruction wherein at least one live instructor conducts the session while at least one, and more preferably two or more, video displays are placed along different lines of sight display the yoga sequences so that the participants can view the monitors from anywhere within the studio. The instructor can demonstrate the same pose as that being shown on the displays, or an easier or more advanced alternative version of the pose, as well as move from student to student during the class, providing feedback on poses and/or suggesting alternate poses for beginners or more advanced students, while the class moves along according to the sequence displayed on the monitors. This allows each student to have the option of watching either the instructor demonstrate or a larger-than-life instructor on the video display(s) since the live instructor can sometimes be difficult to see. Students can see the poses displayed on the video displays, while receiving individual assistance from a live instructor.

### BRIEF DESCRIPTION OF THE DRAWINGS

FIG. 1 is a perspective view of a yoga studio according to the method of the present invention; and

FIG. 2 is a flow chart for carrying out the present invention.

### DETAILED DESCRIPTION OF THE PREFERRED EMBODIMENTS

The present invention is generally described below in connection with the included drawings. This description is intended to be illustrative, and not limiting. There will readily be modifications to the foregoing described preferred embodiments, and the invention is intended to include all such modifications and alternate embodiments.

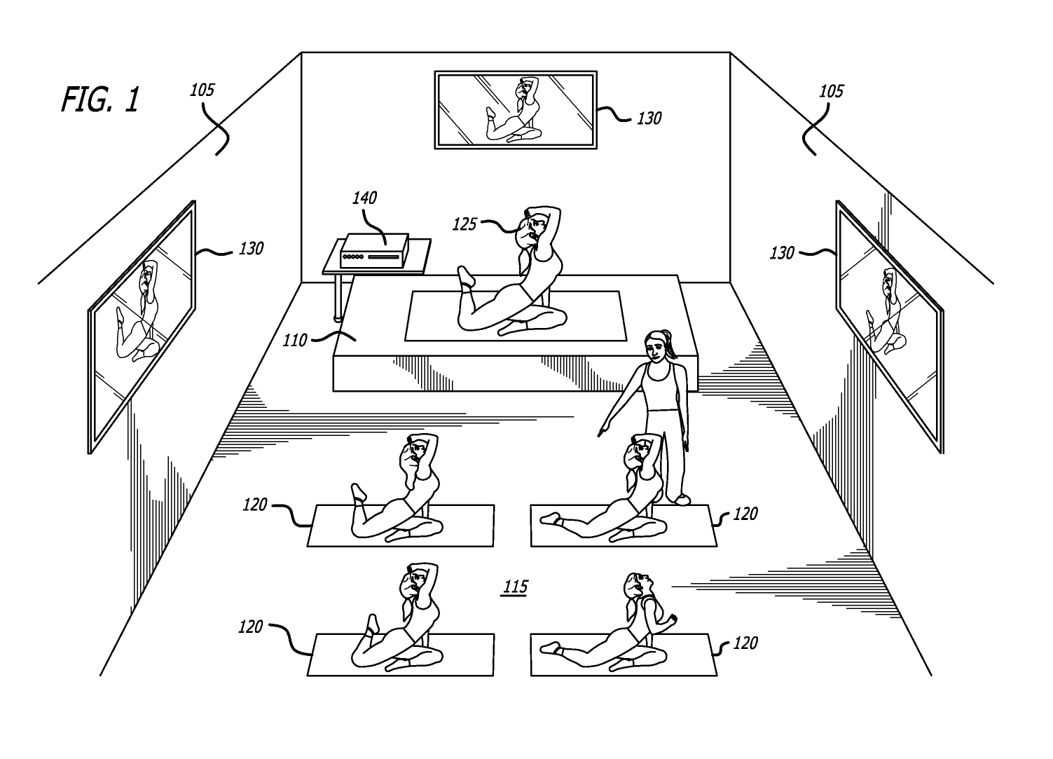

FIG. 1 illustrates a yoga studio that includes a front wall 100, two side walls 105, an optional podium or stage 110, and a work-out area 115 for the students to place their mats 120. The stage area 110 is typically where an instructor 125 would conduct the class, and the elevation of the stage area 110 would allow students to have a better view of the exercises and poses to be performed for this class, although the stage is not essential. In this studio, on the front wall 100, and the two side walls 105, a large television monitor 130 is mounted near the upper portion. The television monitors 130 are connected via cabling (not shown) or wireless connections to a single audio/video source 140, such as a dvd player, media player, or other storage/player. On the audio/video source 140, data is stored or retrieved in preferably a digital format that corresponds with a visual presentation of the yoga class for the particular session. In other words, the audio/video source 140 retrieves the data and converts the data into an image, which is sent to the three television monitors 130 for display to the class. The displays 130 each show the yoga poses and sequences being taught by the instructor 125 for that class, allowing all of the students to view the various poses and hear the recorded instructions from anywhere in the studio, regardless of where they are positioned.

The present invention is both a safety measure and a teaching tool. That is, if the student is doing something wrong or dangerous, or if the student has a question about what the student is practicing, the live instructor is able to move around the room to give instruction and advice to the students on their particular situation, etc., while the students follow the demonstrations and audio instructions broadcast on the monitors. At times, the live instructor may be positioned in the front of the room demonstrating the same asana that is being demonstrated on the video display or the live instructor may demonstrate a simpler or more advanced version of the asana, or a version that is less stressful on a particular body part (e.g., the neck). For example, if there is an advanced version of the asana being shown on the video monitor, then the instructor at the front of the room can be demonstrating an alternate version of that exercise, for example, an easier version for less experienced students. Similarly, if the asana being shown on the monitor is an easy asana, the instructor can demonstrate a more challenging version. The instructor (who may be one or more roving live instructors) could circulate about the room, watching the students carefully and giving corrections where needed while the rest of the students can be watching and following the pose on the screen.

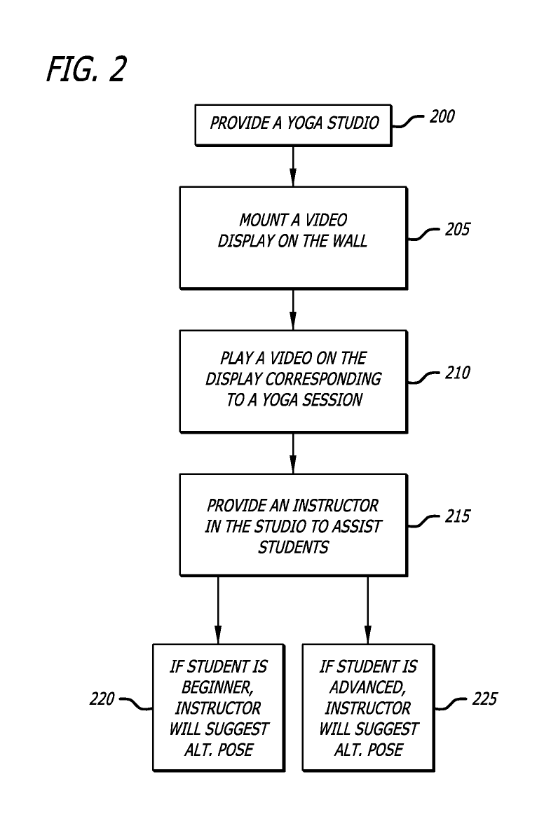

FIG. 2 illustrates a flow chart for the method of the present invention, wherein box 200 illustrates the step of providing a yoga studio, and placing at least one video display on a wall is step 205. Step 210 is associated with connecting the display to a video source that corresponds to a yoga instruction sequence, such as a yoga sequence of poses performed by a yogi, an instructor, or some other manner in which a sequence of poses can be conveyed to the participants in the studio. The display can be still frames or motion, as long as it demonstrates the proper form for the pose, and progresses from one pose to another. Step 215 corresponds to providing a live instructor in the studio, who teaches the class according to the sequences and poses of the video presentation, but also can walk around and assist the students. Step 220 corresponds to providing to beginner students alternate poses that may be more appropriate for beginners, or less skilled students. This may also concern students with health issues, injuries, the elderly, or other students who cannot perform the poses presented in the video. Similarly, in step 225 the instructor can provide more advanced students with more challenging poses, to keep such students advancing in their practice and maintaining their interest.

I claim:

1. A method for teaching yoga to a plurality of students in a yoga studio, the method comprising:
mounting at least one video display;
connecting the video display to a video source;
playing a yoga sequence stored on the video source at the video display so as to be within view of yoga students;
providing a live instructor to demonstrate yoga poses in person to the yoga students that coincide with the yoga poses being displayed on the display, and the live instructor assists individual yoga students while the video displays are operating;
wherein the instructor demonstrates or provides instruction as to alternate poses to the students depending upon the students' skill level and abilities.

2. The method for teaching yoga of claim 1, wherein the video source is a dvd player.

3. The method for teaching yoga of claim 1, wherein the instructor demonstrates an alternate pose when the student is a beginner.

4. The method for teaching yoga of claim 1, wherein the instructor demonstrates an alternate pose when the student is advanced.

5. The method for teaching yoga of claim 1, wherein another instructor circulates among the students while the first instructor demonstrates an alternate pose to a pose shown on the video display.
